(19) United States
(12) Patent Application Publication
(10) Pub. No.: US 2025/0015573 A1
(43) Pub. Date: Jan. 9, 2025

(54) CABLE RETAINER ASSEMBLIES AND METHODS OF RETAINING CABLES

(71) Applicant: Preformed Line Products Company, Mayfield, OH (US)

(72) Inventors: Nicholas Lees, Lakewood, OH (US); Jacob Palmer, Chesterland, OH (US)

(21) Appl. No.: 18/218,137

(22) Filed: Jul. 5, 2023

(51) Int. Cl. H02G 3/06; H02G 3/08

(52) U.S. Cl. CPC H02G 3/0691; H02G 3/083

(57) ABSTRACT

A cable retainer assembly includes a body having a proximal end, a distal end positioned opposite the proximal end, and a body length that extends from the proximal end to the distal end. A plurality of projections extend laterally about the body in a circumferential direction, a plurality of slots are defined between each of the plurality of projections, and a plurality of tapered cross members extend perpendicularly from each of the plurality of projections. A plurality of wedges are configured to be received by the plurality of slots, and each of the plurality of wedges are tapered. Each of the plurality of wedges are retained in each of the plurality of slots when each of the plurality of wedges translates from the proximal end of the body towards the distal end of the body.

### TECHNICAL FIELD

The present specification generally relates to cable retainers, and more specifically, to wedge-style cable retainer assemblies.

### BACKGROUND

Fiber optic cable installations often require the use of cable retainer devices to secure the cables at attachment locations, such as utility poles. Conventional wedge-style dead-end retainers are often preferred by installers due to their perceived simplicity and ease of installation. However, these conventional retainers are only capable of retaining a single cable, which may result in attachment locations becoming overcrowded. Accordingly, a need exists for a cable retainer that is capable of retaining multiple cables while providing the simplicity and ease of installation of conventional wedge-style dead-end retainers.

### SUMMARY

In an embodiment, a cable retainer assembly is disclosed. The cable retainer assembly includes a body having a proximal end, a distal end positioned opposite the proximal end, and a body length extending from the proximal end to the distal end. A plurality of projections extend laterally about the body in a circumferential direction, and a plurality of slots defined between each of the plurality of projections. A plurality of cross members extend perpendicularly from each of the plurality of projections, and each of the plurality of cross members are tapered. A plurality of wedges are configured to be received by the plurality of slots, and each of the plurality of wedges are tapered, such that each of the plurality of wedges are retained in each of the plurality of slots when each of the plurality of wedges translates from the proximal end of the body towards the distal end of the body.

In another embodiment, a cable retainer assembly is disclosed. The cable retainer assembly includes a body having a proximal end, a distal end positioned opposite the proximal end, a body length extending from the proximal end to the distal end, and a plurality of sides extending along the body length. A plurality of channels are formed in each of the plurality of sides, and a plurality of slots are defined within each of the plurality of channels, with each of the plurality of slots being tapered. A plurality of wedges are configured to be received by the plurality of slots, and each of the plurality of wedges are tapered, such that each of the plurality of wedges are retained in each of the plurality of slots when each of the plurality of wedges translates from the proximal end of the body towards the distal end of the body.

In yet another embodiment, a method of securing cables within a cable retainer assembly is disclosed. The method involves securing the cable retainer assembly to an attachment location using an attachment cable that extends through a central opening of the cable retainer assembly; inserting a first cable of a plurality of cables into a first slot of a plurality of slots defined between a plurality of projections that extend from a body of the cable retainer assembly; securing a first wedge of a plurality of wedges to at least a portion of the first cable; translating the first cable such that the first wedge is drawn into the first slot; securing the first wedge within the first slot, such that the first cable is secured within the first slot of the body of the cable retainer assembly; and repeating each of the recited method steps such that each of the plurality of cables are secured within each of the plurality of slots of the cable retainer assembly.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of a cable secured to a cable retainer assembly, according to one or more embodiments shown and described herein;

FIG. 2A depicts a perspective view of a body of the cable retainer assembly of FIG. 1, according to one or more embodiments shown and described herein;

FIG. 2B depicts a front side view of the body of the cable retainer assembly of FIG. 2A, according to one or more embodiments shown and described herein;

FIG. 3A depicts a top-side perspective view of a wedge for securing the cable within the cable retainer assembly of FIG. 1, according to one or more embodiments shown and described herein;

FIG. 3B depicts a bottom-side perspective view of the wedge for securing the cable within the cable retainer assembly of FIG. 3B, according to one or more embodiments shown and described herein;

FIG. 3C depicts a front view of the wedge of FIGS. 3A and 3B engaging a cable, according to one or more embodiments shown and described herein;

FIG. 4 depicts a perspective view of another embodiment of a cable retainer assembly, according to one or more embodiments shown and described herein;

FIG. 5 depicts a perspective view of a body of the cable retainer assembly of FIG. 4, according to one or more embodiments shown and described herein;

FIG. 6 depicts a bottom-side perspective view of a wedge for securing a cable within the cable retainer assembly of FIG. 4, according to one or more embodiments shown and described herein; and

FIG. 7 depicts an illustrative flow diagram of a method of securing a cable to a cable retainer assembly, according to one or more embodiments shown and described herein.

### DETAILED DESCRIPTION

Embodiments disclosed herein relate to cable retainer assemblies and methods of retaining cables. More specifically, the present disclosure relates to a cable retainer assembly including a body having a proximal end, a distal end positioned opposite the proximal end, and a body length extending from the proximal end to the distal end. A plurality of projections extend laterally about the body in a circumferential direction, and a plurality of slots are defined between each of the plurality of projections (e.g., between each pair of adjacent projections). In these embodiments, the cable retainer further includes a plurality of cross members that extend perpendicularly from each of the plurality of projections, with each of the plurality of cross members being tapered from a first cross member end to a second cross member end. A plurality of wedges are configured to be received by the plurality of slots, and each of the plurality of wedges are tapered from a first wedge end to a second wedge end, such that, when each of the plurality of wedges are inserted into each of the plurality of slots, each of the plurality of wedges become secured within each of the plurality of slots as each of the plurality of wedges are advanced through each of the plurality of slots from the proximal end of the body towards the distal end of the body. Each of the plurality of wedges may be further configured to engage a cable, such as a fiber optic cable, prior to being inserted into each of the plurality of slots. Accordingly, securing each of the plurality of wedges within each of the plurality of slots may further cause the cable to become secured within the cable retainer assembly.

As provided herein, the term “cable” may refer to a thin, flexible strand or rod of metal (e.g., copper, aluminum, etc.) used for conducting electricity and/or transmitting signals. For example, the term “cable” may include lines, mono-filament wires, stranded wires, multiple/bundled cables or wires, fiber optic line(s), overhead shielded wires, conductors, optical ground wires (OPGW), and all-dielectric self-supporting fiber optic cables (ADSS). In these embodiments, the cables may be insulated or uninsulated and used for various applications, including power transmission, telecommunications, or data networking.

As should be appreciated, traditional cable retainers, such as conventional wedge-style dead-ends, are often preferred by installers due to their simplicity and ease of installation. However, these retainers are only capable of securing a single cable, which necessitates the use of multiple retainers in order to retain multiple cables. As a result, attachment locations (e.g., utility poles, etc.) become crowded due to the presence of numerous retainers, which may cause cluttering that can lead to inefficiencies in securing multiple cables.

To address these shortcomings, the disclosed cable retainer assembly enables the restraint of multiple cables using a single retainer. For example, the cable retainer assembly described herein includes a body member that is capable of receiving a plurality of cables, thereby providing a compact footprint that may minimize the space consumed by the cable retainer assembly on the attachment location. The cable retainer assembly described herein may further provide additional flexibility which is not offered by current retainers. For example, the cable retainer assembly may be configured to accommodate cables of varying sizes within a single cable retainer.

Embodiments of cable retainer assemblies and methods of retaining cables will now be described in additional detail herein. The following will now described these cable retainer assemblies and methods in more detail with reference to the drawings and where like numbers refer to like structures.

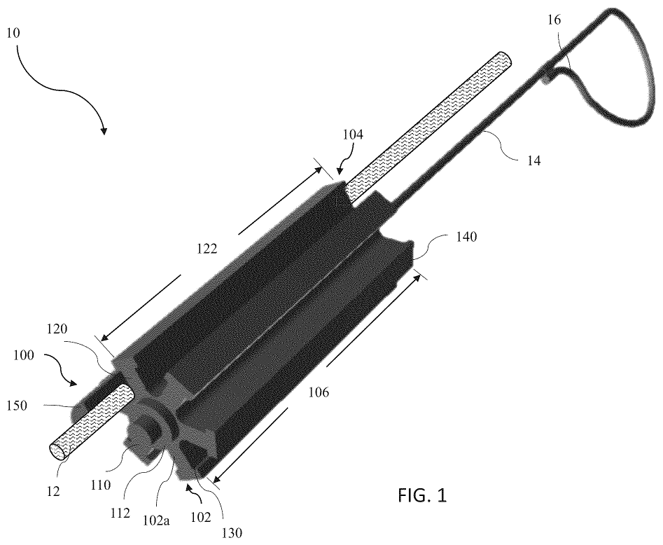

Referring now to FIG. 1, a perspective view of a cable retainer assembly 10 is depicted engaging a cable 12. As depicted in FIG. 1, the cable retainer assembly 10 may include a body 100 having a proximal end 102, a distal end 104, and a body length 106 that extends between the proximal end 102 and the distal end 104. In these embodiments, the body 100 may further include a proximal face 102a positioned at the proximal end 102 of the body 100, with a central opening 110 being formed in the proximal face 102a of the body. The central opening 110 may extend from the proximal end 102 of the body 100 to the distal end 104 of the body 100 (e.g., through the body length 106). In these embodiments, an attachment mechanism 14 may be inserted through the central opening 110, and may be used to secure the cable retainer assembly 10 to an attachment location (e.g., utility pole, etc.). In these embodiments, the attachment mechanism 14 may be a cable, wire, bail, plastic component, or any other similar mechanism capable of coupling the cable retainer assembly 10 to the attachment location. Although the attachment mechanism 14 is depicted as being inserted through the central opening 110 in FIG. 1, it should be further appreciated that, in some embodiments, the attachment mechanism 14 may interface and/or connect to various locations on the exterior of the cable retainer assembly 10 without departing from the scope of the present disclosure.

As further depicted in FIG. 1, the attachment mechanism 14 may be secured within the central opening 110 via a fastener 112, such as a hex head or other similar screw or bolt. The attachment mechanism 14 may further include a looped end 16 (e.g., looped back on itself via a crimp or other similar fastening mechanism) which is used to secure the attachment mechanism 14 and cable retainer assembly 10 to the attachment location. Although the attachment mechanism 14 is depicted as including looped end 16, it should be appreciated that the attachment mechanism 14 may be secured to the attachment location using any suitable connection mechanism (e.g., bolt, screw, fastener, etc.)

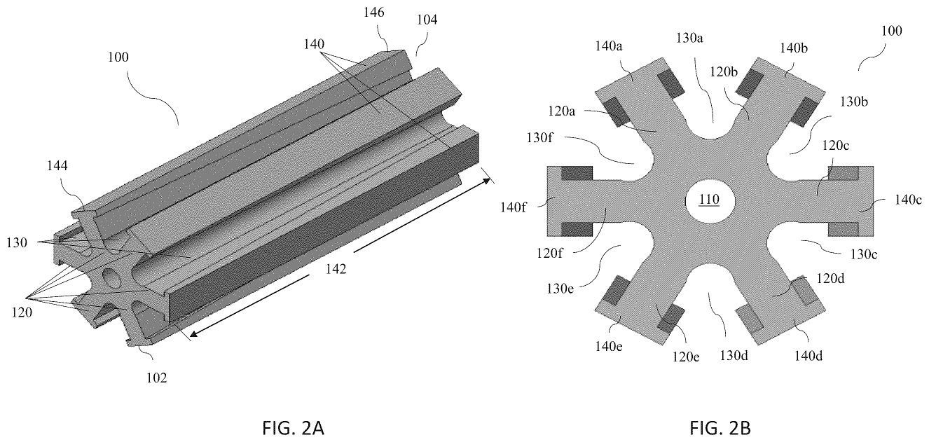

Referring still to FIG. 1, the body 100 may further include a plurality of projections 120 that extend laterally from the body 100 in a circumferential direction. In these embodiments, each of the plurality of projections 120 may extend along the body length 106 of the body 100 (e.g., from the proximal end 102 to the distal end 104). Furthermore, the plurality of projections 120 may define a plurality of slots 130 that extend along the body length 106 of the body 100. As further depicted in FIG. 1, a plurality of cross members 140 may extend perpendicularly from each of the plurality of projections 120 along the body length 106 of the body 100. The plurality of projections 120, the plurality of slots 130, and the plurality of cross members 140 will be described in additional detail herein with reference to FIGS. 2A and 2B.

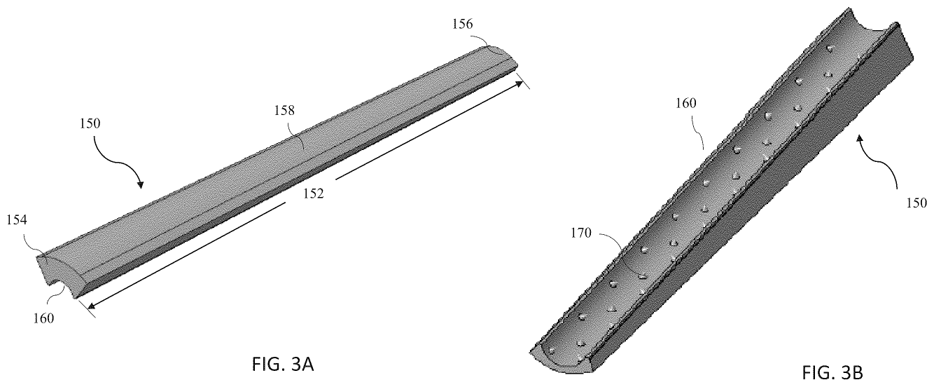

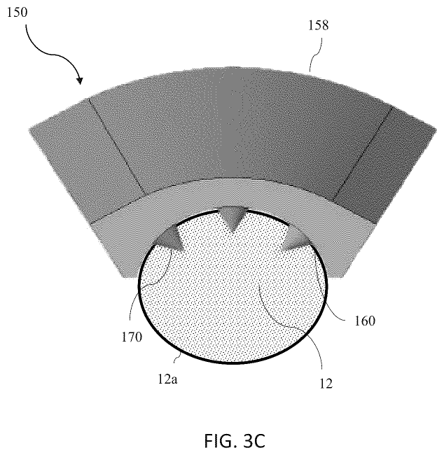

As further depicted in FIG. 1, the cable retainer assembly 10 may further include a plurality of wedges 150. In these embodiments, each of the plurality of wedges 150 may be configured to engage a cable 12. Furthermore, each of the plurality of wedges 150 may be configured to be received by each of the plurality of slots 130. For example, as depicted in FIG. 1, once the plurality of wedges 150 engage their respective cables 12, each of the plurality of wedges 150 may be pulled into each of the plurality of slots 130 (e.g., entering the proximal end 102 of the body 100 and translating towards the distal end 104 of the body 100) such that each of the plurality of wedges 150 become secured within each of the plurality of slots 130. The plurality of wedges 150 will be described in additional detail herein with reference to FIGS. 3A-3C.

Referring now to FIGS. 2A and 2B, the body 100 of the cable retainer assembly 10 is depicted in additional detail. As noted herein, the body 100 may include a plurality of projections 120 that define a plurality of slots 130, and a plurality of cross members 140 may extend perpendicularly from each of the plurality of projections 120. For example, as depicted in FIGS. 2A and 2B, the plurality of projections 120 may include six projections, such as projections 120a-120f. In these embodiments, the plurality of slots 130 may be defined by each pair of adjacent projections 120, such that the number of slots 130 is equal to the number of projections 120. For example, as depicted in FIGS. 2A and 2B, the plurality of projections 120 may define six slots 130a-130f. In these embodiments, a first projection 120a and a second projection 120b may define a first slot 130a, while the second projection 120b and a third projection 120c may define a second slot 130b. It should be appreciated that the remaining projections 120 and slots 130 may be similarly defined about the body 100 in the circumferential direction.

As further depicted in FIGS. 2A and 2B, the body 100 may include a plurality of cross members 140 that extend perpendicularly from each of the plurality of projections 120, such that each of the plurality of projections 120 includes a single cross member 140. For example, as illustrated in FIGS. 2A and 2B, the body 100 may include six cross members 140a-140f, with each cross member 140a-140f being associated with a respective projection 120a-120f. In these embodiments, the plurality of cross members 140 may extend perpendicularly from the plurality of projections 120 such that the plurality of projections 120 and the plurality of cross members 140 form a generally T-shaped cross-section.

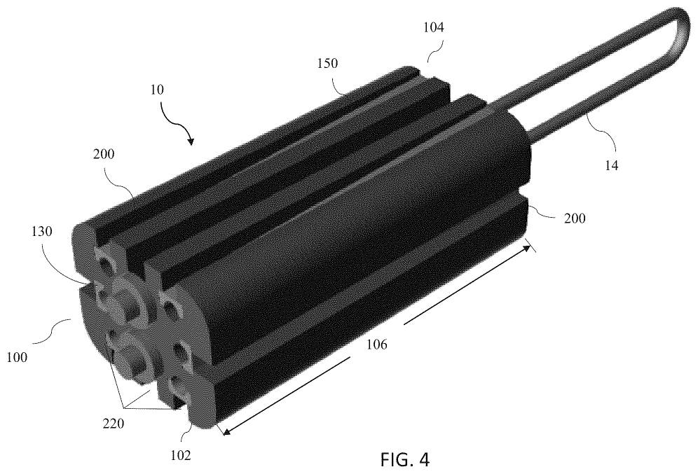

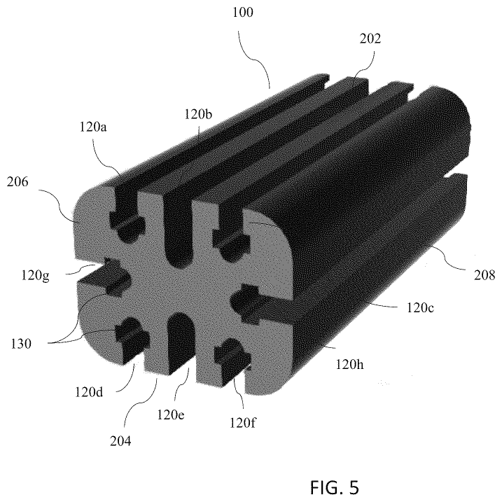

In the embodiment depicted in FIGS. 2A and 2B, the body 100 may have a generally circular shape. However, it should be appreciated that the body 100 may take any shape without departing from the scope of the present disclosure. For example, the body 100 may have a square, rectangular, triangular, octagonal, or any other similar shape. Embodiments of a cable retainer assembly 10 having a rectangular shape will be described in additional detail with reference to FIGS. 4-7.

Furthermore, in the embodiment depicted in FIGS. 2A and 2B, each of the plurality of projections 120 may extend along the body length 106 of the body 100 from the proximal end 102 of the body 100 to the distal end 104 of the body 100. However, in some embodiments, each of the plurality of projections 120 may not extend fully from the proximal end 102 of the body 100 to the distal end 104 of the body 100. For example, in some embodiments, a gap may exist between the proximal end 102 and/or the distal end 104 of the body 100 and each of the plurality of projections 120, such that each of the plurality of projections 120 have a projection length 122 that is shorter than the body length 106. In other embodiments, each of the plurality of projections 120 may have a projection length 122 that is longer than the body length 106 of the body 100, such that each of the plurality of projections 120 may extend beyond (e.g., in the +/−x-direction as depicted in the coordinate axes of FIGS. 2A-2B) the proximal end 102 and/or the distal end 104 of the body 100. It should also be noted that, although each of the plurality of projections 120a-120f are depicted as having the same projection length 122, in some embodiments, the plurality of projections 120a-120f may have varying lengths (e.g., the first projection 120a may have a first length that is different from a second length of the second projection 120b, etc.).

It should be further appreciated that the plurality of projections 120 may include any number of projections 120 without departing from the scope of the present disclosure. For example, although FIGS. 2A and 2B depict the plurality of projections 120 as including six projections 120a-120f, the plurality of projections 120 may include any number of projections, such as two, three, four, five, or six projections. However, it should be noted that, in these embodiments, the plurality of projections 120 may include at least two projections 120, such that the plurality of projections 120 are able to define at least one slot 130.

Similarly, in the embodiment depicted in FIGS. 2A and 2B, each of the plurality of cross members 140 may extend along the projection length 122 of each of the plurality of projections 120. However, in some embodiments, each of the plurality of cross members may not extend fully along the projection length 122 of each of the plurality of projections 120. For example, in some embodiments, the plurality of cross members 140 may have a cross member length 142 that is longer or shorter than the projection length 122 of each of the plurality of projections 120. Furthermore, it should be appreciated that, although the plurality of cross members 140a-140f are depicted as having the same cross member length 142, in some embodiments, the plurality of cross members 140a-140f may have varying lengths (e.g., the first cross member 140a may have a first length that is different from a second length of a second cross member 140b, etc.)

In the embodiments described herein, it should be appreciated that the number of the plurality of projections 120 may correspond to the number of the plurality of slots 130 and the number of the plurality of cross members 140. For example, as depicted in FIGS. 2A and 2B, the body 100 includes six projections 120a-120f, six slots 130a-130f, and six cross members 140a-140f.

Referring still to FIGS. 2A and 2B, each of the plurality of cross members 140 may be tapered. For example, as illustrated in FIGS. 2A and 2B, each of the plurality of cross members 140 may have a first end 144 having a first thickness and a second end 146 having a second thickness. In these embodiments, the first thickness of the first end 144 (e.g., positioned at the proximal end 102 of the body 100) may be less than the second thickness of the second end 146 (e.g., positioned at the distal end 104 of the body 100), such that the thickness of each of the plurality of cross members 140 increases along the cross member length 142 of the cross member 140 from the first end 144 of the cross member 140 to the second end 146 of the cross member 146.

Because each of the plurality of cross members 140 may be tapered, it should be appreciated that, in these embodiments, a distance (e.g., in the lateral direction) between each of the plurality of slots 130 and each of the plurality of cross members 140 may decrease along the body length 106 of the body 100. For example, as depicted in FIGS. 2A and 2B, each of the plurality of cross members 140 may be spaced a first distance from each of the plurality of slots 130 at the proximal end 102 of the body 100. Similarly, each of the plurality of cross members 140 may be spaced at a second distance that is less than the first distance from each of the plurality of slots 130 at the distal end 104 of the body 100. Accordingly, it should be appreciated that the distance between each of the plurality of slots 130 and each of the plurality of cross members 140 may decrease along the body length 106 of the body 100 from the proximal end 102 of the body 100 to the distal end 104 of the body 100. For example, the distance between each of the plurality of cross members 140 and each of the plurality of slots 130 may decrease along the body length 106 of the body 100 as the thickness of each of the plurality of cross members 140 increases. In these embodiments, the tapering of each of the plurality of cross members 140 may aid in securing each of the plurality of wedges 150 within each of the plurality of slots 130, as will be described in additional detail herein.

Referring now to FIGS. 1 and 3A-3C, the plurality of wedges 150 are depicted in additional detail. As illustrated in FIGS. 3A-3C, each of the plurality of wedges 150 may have a wedge length 152 that extends from a first end 154 of the wedge 150 to a second end 156 of the wedge 150. In these embodiments, the wedge length 152 may equal the body length 106 of the body 100, such that each of the plurality of wedges 150 are aligned with the body 100 when each of the plurality of wedges 150 are inserted into their respective slots 130. However, it should be further appreciated that, in some embodiments, the wedge length 152 may be different from the body length 106 of the body 100, such that each of the plurality of wedges 150 extend from the proximal end 102 and/or distal end 104 of the body 100 or are contained within each of the plurality of slots 130 of the body 100.

As further depicted in FIGS. 1 and 3A-3C the plurality of wedges 150 may further include a first surface 158 and a second surface 160 opposite the first surface 158. In these embodiments, each of the first surface 158 and the second surface 160 may be curved, such that each of the plurality of wedges 150 may be received by each of the plurality of slots 130. For example, the curved profile of each of the plurality of wedges 150 may correspond to the circular shape of the body 100 (FIGS. 1 and 2A-2B) such that each of the plurality of wedges 150 may be easily inserted into the body 100. It should be appreciated that, in these embodiments, each of the plurality of wedges 150 may include a profile that matches the shape of the body 100. For example, in embodiments in which the body 100 includes a rectangular, square, triangular, or octagonal shape, each of the plurality of wedges 150 may include a similarly shaped profile such that each of the plurality of wedges 150 may be easily received by the plurality of slots 130 formed in the body 100.

Referring still to FIGS. 1 and 3A-3C, the plurality of wedges 150 may be tapered, such that each of the plurality of wedges 150 may be configured to be received by each of the plurality of slots 130 (e.g., between each of the plurality of cross members 140 and the body 100). In these embodiments, the first end 154 of each of the plurality of wedges 150 may include a first thickness and the second end 156 of each of the plurality of wedges 150 may include a second thickness, with the first thickness of the first end 154 being less than the second thickness of the second end 156. Accordingly, in these embodiments, the thickness of each of the plurality of wedges 150 decreases along the wedge length 152 of the wedge 150 from the first end 154 of the wedge 150 to the second end 156 of the wedge. In these embodiments, each of the plurality of wedges 150 may be tapered at a wedge taper angle that is equivalent to a cross member taper angle, such that each of the plurality of wedges 150 may be received within each of the plurality of slots 130 (e.g., between each of the plurality of cross members 140 and the body 100).

As most clearly depicted in FIGS. 3B and 3C, each of the plurality of wedges 150 may further include a plurality of teeth 170 positioned on at least one surface (e.g., the second surface 160 as depicted in FIGS. 3B and 3C) that may engage the cable 12. For example, in these embodiments, the plurality of teeth 170 may include a number of sharpened edges (e.g., beveled, serrated, flat, abrasive, etc.) that may penetrate an outer perimeter 12a of the cable 12 and secure the cable 12 to the wedge 150. In operation, the cable 12 may be placed within one of the plurality of slots 130, at which point one of the plurality of wedges 150 may be secured to the cable 12. The wedge 150 may then be drawn into the slot 130 by pulling the cable 12 (e.g. in the −x-direction as depicted in the coordinate axis of FIGS. 3A-3B), such that the wedge 150 and cable 12 become secured within the body 100, as will be described in additional detail herein. In these embodiments, it should be appreciated that the sectionalized nature of the wedges (e.g., the plurality of wedges 150) may allow for additional cables 12 to be secured to the cable retainer assembly 10 without impacting any adjacent cables 12 positioned within the body 100 of the cable retainer assembly 10. For example, the cable retainer assembly 10 may initially be fitted with a first cable when then cable retainer assembly 10 is coupled to the attachment location. However, additional cables (e.g., a second cable, third cable, etc.) may be fitted into the remaining plurality of slots 130 and secured with additional wedges 150 without disrupting the security of the first cable after the cable retainer assembly 10 is secured to the attachment location.

Referring again to FIGS. 1-3C, although the cable retainer assembly 10 is depicted as including a plurality of wedges 150, it should be noted that, in some embodiments, the cable retainer assembly 10 may include one wedge 150 formed as a single monolithic structure. For example, in these embodiments, the wedge 150 may have a circular shape with a number of projections that are configured to engage with a plurality of cables 12 and be received by the plurality of slots 130 of the body 100. In these embodiments, the single wedge 150 may be inserted into the body 100 of the cable retainer assembly 10 in order to retain multiple cables 12 within the cable retainer assembly 10 simultaneously.

Referring still to FIGS. 1-3C, it should be noted that each of the plurality of wedges 150 may be configured to secure the cable 12 to hold up to at least 300 pounds. For example, in the embodiments depicted in FIGS. 1-3C, the cable retainer assembly 10 may be capable of retaining six cables 12 that cumulatively support 1,800 pounds (e.g., up to 300 pounds per cable). However, it should be appreciated that, in some embodiments, the cable retainer assembly 10 may be modified to retain various cables of different shapes and/or sizes in order to modify the load that is able to be supported by the cable retainer assembly 10.

For example, with reference to FIGS. 1-3C, it may be possible to alter the load supported by the cable retainer assembly 10 by modifying the angle at which each of the plurality of cross members 140 and each of the plurality of wedges 150 are tapered. In these embodiments, a shallower taper angle may allow each of the plurality of wedges 150 to support a greater load within the cable retainer assembly. For example, a shallower taper angle may increase the contact area between each of the plurality of wedges 150 and the body 100. Accordingly, the larger contact area may allow for the load supported by the cable 12 to be distributed over a larger surface area, which may allow for improved load-bearing capacity and enhanced stability. In contrast, a steeper taper angle would provide the cable retainer assembly 10 with a tighter grip that may be more suitable for retaining cables 12 with relatively lower load requirements and/or smaller diameters.

In these embodiments, it should be further appreciated that each of the plurality of wedges 150 and each of the plurality of cross members 140 may include different taper angles, which may allow the cable retainer assembly 10 to retain cables of varying sizes and/or load requirements in a single retainer.

Referring again to FIGS. 1-3C, the connection of the plurality of wedges 150 within the body 100 of the cable retainer assembly 10 will now be described in additional detail. As has been noted herein, each of the plurality of wedges 150 may be secured to its respective cable 12 using the plurality of teeth 170 positioned on at least one surface of each of the plurality of wedges 150. Once the plurality of wedges 150 are secured to their respective cables 12, the cables 12 may be pulled through the body 100 (e.g., in the −x-direction depicted in the coordinate axis of FIG. 1) such that the second end 156 of each of the plurality of wedges 150 engages the first end 144 of each of the plurality of cross members 140 at the proximal end 102 of the body 100. As the plurality of wedges 150 engage the plurality of cross members 140, the cables 12 may become secured within each of the plurality of slots 130 (e.g., between each of the plurality of wedges 150 and the body 100).

In these embodiments, each of the cables 12 may be continuously pulled (e.g., in the −x-direction as depicted in the coordinate axis of FIG. 1) such that each of the plurality of wedges 150 translate from the proximal end 102 of the body towards the distal end 104 of the body 100. The cables 12 may continue to move towards the distal end 104 of the body 100 until each of the plurality of wedges 150 becomes wedged within its respective slot 130 (as may be determined based on the taper angle of each of the plurality of wedges 150 and each of the plurality of cross members 140).

As each of the plurality of wedges 150 is pulled towards the distal end 104 of the body 100 of the cable retainer assembly 10, a frictional force acting between each of the plurality of wedges 150 and the body 100 (e.g., and plurality of projections 120 and plurality of cross members 140) may act to secure each of the plurality of wedges 150 within its respective slot 130. In these embodiments, it should be appreciated that the frictional force between each of the plurality of wedges 150 and the cables 12 may be greater than the frictional force acting between the plurality of wedges 150 and the body 100 of the cable retainer assembly 10, such that the cables 12 do not become separated from the plurality of wedges 150 as the plurality of wedges 150 are inserted into the plurality of slots 130.

Referring still to FIGS. 1-3C, it should be appreciated that the plurality of wedges 150 may become secured within each of the plurality of slots 130 at varying distance, as may be determined based on the taper angle of both the plurality of wedges 150 and the plurality of cross members 140. For example, in some embodiments, each of the plurality of wedges 150 may be drawn into the plurality of slots 130 such that the first end 154 of each of the plurality of wedges 150 lies flush with the proximal face 102a of the proximal end 102 of the body 100 of the cable retainer assembly 10. In these embodiments, each of the plurality of wedges 150 may extend through each of the plurality of slots 130, such that the first end 154 of each of the plurality of wedges 150 aligns with the proximal end 102 of the body 100 and the second end 156 of each of the plurality of wedges 150 aligns with the distal end 104 of the body 100.

However, in other embodiments, the plurality of wedges 150 may become secured within the plurality of slots 130 such that each of the plurality of wedges 150 are not aligned within each of the plurality of slots 130. For example, as depicted in FIG. 1, the plurality of wedges 150 may become secured within the plurality of slots 130 before the second end 156 of the plurality of wedges 150 is aligned with the distal end 104 of the body 100, such that at least a portion of the plurality of wedges 150 extends (e.g., in the +x-direction as depicted in the coordinate axis of FIG. 1) from the proximal end 102 of the body 100. As has been noted herein, it should be appreciated that varying the taper angles of the plurality of wedges 150 and the plurality of cross members 140 may alter the position at which the plurality of wedges 150 become secured within the plurality of slots 130. For example, in embodiments in which the taper angle of the plurality of wedges 150 is greater than the taper angle of the plurality of cross members 140, the plurality of wedges 150 may become secured within the plurality of slots 130 such that at least a portion of the plurality of wedges 150 extend from the proximal end 102 of the body 100.

Furthermore, although not depicted, it should be appreciated that, in some embodiments, the plurality of wedges 150 may be secured within the plurality of slots 130 such that the second end 156 of the plurality of wedges 150 extends beyond the distal end 104 of the body (e.g., in the −x-direction as depicted in the coordinate axis of FIG. 1). In these embodiments, the taper angle of the plurality of wedges 150 may be less than the taper angle of the plurality of wedges 150, such that the plurality of wedges 150 are not secured within the plurality of slots 130 until at least a portion of the plurality of wedges 150 extends beyond the distal end 104 of the body.

In embodiments in which at least a portion of the plurality of wedges 150 extends from the body 100 when the plurality of wedges 150 are secured within the plurality of slots 130 (e.g., either extending from the proximal end 102 or distal end 104 of the body 100), the cable retainer assembly 10 may further include a ratcheting mechanism to aid in securing the portion that extends from the body 100 within the cable retainer assembly 10. For example, the cable retainer assembly 10 may include a spring-loaded ratcheting mechanism, an interlocking ratcheting mechanism, a cam-locking ratcheting mechanism, or any other similar mechanism that may ensure the stability of the plurality of wedges 150 within the cable retainer assembly 10.

Referring now to FIGS. 4-6, another embodiment of a cable retainer assembly 10′ is illustrated. It should be appreciated that the cable retainer assembly 10′ is similar to the cable retainer assembly 10 described herein and depicted in FIGS. 1-3C. As such, like structure is indicated with like reference numerals.

In the embodiments depicted in FIGS. 4-6, the cable retainer assembly 10′ may include a body 100 having a proximal end 102, a distal end 104, and a body length 106 that extends between the proximal end 102 and the distal end 104. The cable retainer assembly 10′ may further include a plurality of sides 200 that extend from the proximal end 102 to the distal end 104 of the body 100. For example, as depicted in FIGS. 4-7, the body 100 may include a first side 202 (e.g., top side) positioned opposite a second side 204 (e.g., bottom side), and a third side 206 (e.g., left side) positioned opposite a fourth side 208 (e.g., right side), such that the body 100 has a generally square or rectangular shape.

In these embodiments, the plurality of sides 200 of the body 100 may further include a plurality of channels 220 that extend through each of the plurality of sides 200 (e.g., from the proximal end 102 to the distal end 104 of the body 100). For example, as depicted most clearly in FIG. 5, the first side 202 may include three channels 220a-220c, the second side 204 may include three channels 220d-220f, and the third side 206 and fourth side 208 may each include a single channel 220g, 220h.

As further depicted in FIGS. 4-6, at least one of the plurality of channels 220 may be formed as an opening for receiving an attachment mechanism 14. For example, as depicted in FIGS. 4 and 5 an attachment mechanism 14 may be inserted through channels 220b, 220e, and may be used to secure the cable retainer assembly 10 to an attachment location (e.g., utility pole, etc.). In these embodiments, the attachment mechanism 14 may be secured within the channels 220b, 220e, using a hex head or other similar screw or bolt. In these embodiments, the attachment mechanism 14 may positioned about the attachment location prior to being secured within channels 220b, 220e.

Referring still to FIGS. 4-6, the plurality of channels 220 that do not receive the attachment mechanism 14 may be configured to receive a plurality of wedges 150. In these embodiments, the plurality of channels 220 that are configured to receive the plurality of wedges 150 may further define a plurality of slots 130. For example, as depicted in FIGS. 4 and 5, channels 220a, 220c, 220d, 220e, 220g, and 220h each include a respective slot 130. In these embodiments, the slot 130 may be sized and/or shaped to conform to a size and/or shape of the plurality of wedges 150, as has been described in detail herein with reference to FIGS. 1-4. It should be appreciated that the cable retainer assembly 10′ depicted in FIGS. 4-6 is for illustrative purposes only, and the plurality of channels 220 and the plurality of slots 130 may be arranged in any manner and on any of the plurality of sides 200 of the body 100 without departing from the scope of the present disclosure.

In the embodiments described herein, each of the plurality of slots 130 may be tapered (e.g., along the body length 106 from the proximal end 102 to the distal end 104 of the body 100), such that, as each of the plurality of wedges 150 are inserted into their respective slots, the plurality of wedges 150 become secured within the plurality of slots 130. For example, as the plurality of wedges 150 translate through the plurality of slots 130 (e.g., from the proximal end 102 of the body 100 towards the distal end 104 of the body), the tapering of the plurality of slots 130 may cause the plurality of wedges 150 to become wedged within the plurality of slots 130, as has been described in detail herein.

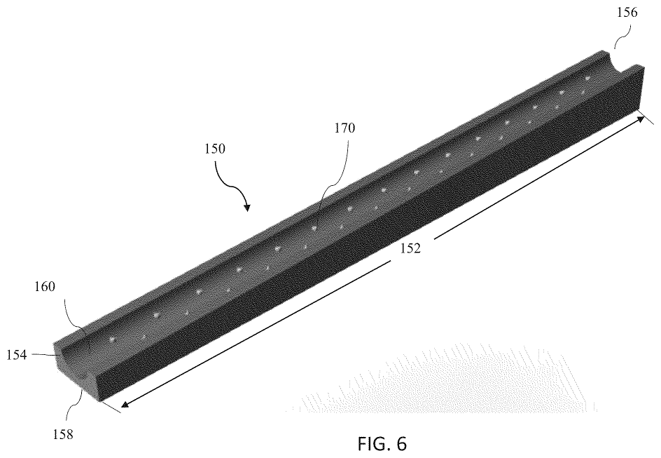

As most clearly evidenced in FIG. 6, each of the plurality of wedges 150 sized and/or shaped to conform to the plurality of slots 130. For example, as depicted in FIG. 6, each of the plurality of wedges 150 may include a generally square or rectangular profile, such that each of the plurality of wedges 150 may be received by the plurality of slots 130 (which may be similarly shaped, as depicted in FIG. 5). Furthermore, each of the plurality of wedges 150 may be similarly tapered along a wedge length 152 that extends from a first wedge end 154 to a second wedge end 156. As has been described herein, adjusting the angle at which the plurality of wedges 150 and/or the plurality of slots 130 are tapered may impact engagement between the plurality of wedges 150 and the plurality of slots 130, and, in turn, the load that the cable retainer assembly 10′ may support. In the embodiments depicted in FIGS. 4-6, each of the plurality of wedges 150 may further include a plurality of teeth 170 that may be used to secure the plurality of wedges 150 to a cable, as has been described in detail herein with reference to FIGS. 1-3.

In view of the foregoing, it should be appreciated that the cable retainer assemblies depicted in FIGS. 1-3 and in FIGS. 4-6 are each illustrative in nature, and the cable retainer assembly may take any shape and/or size such that the plurality of slots formed in the body 100 of the cable retainer assembly are configured to receive the plurality of wedges in order to secure a plurality of cables within the cable retainer assembly.

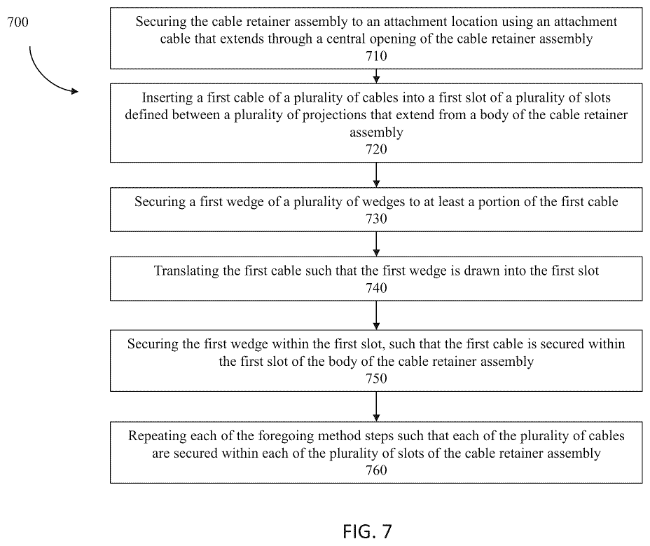

Turning now to FIG. 7, an illustrative flow diagram of a method 700 of securing cables to a cable retainer assembly is depicted. As illustrated in FIG. 7, the method 700 may begin with securing the cable retainer assembly to an attachment location using an attachment mechanism, as shown at block 710. With the cable retainer secured to the attachment location, the method may advance to block 720, which may involve inserting a first cable of a plurality of cables into a first slot of a plurality of slots formed within a body of the cable retainer assembly, as shown at block 720.

With the first cable positioned within the first slot of the body of the cable retainer assembly, a first wedge of a plurality of wedges may be secured to at least a portion of the first cable, as depicted at block 730. In these embodiments, the first wedge of the plurality of wedges may include a plurality of teeth, which may penetrate the first cable and secure the first wedge to the first cable. Furthermore, the first wedge may be secured to a portion of the first cable that extends proximally from the body of the cable retainer assembly, such that translation of the cable (e.g., towards the attachment location) causes the first wedge to be drawn towards the body of the cable retainer assembly.

Once the first wedge has been secured to the first cable, the method may move to block 740, which may involve translating the cable such that the first wedge is drawn into the first slot of the plurality of slots. The method may continue to block 750, which may further involve securing the first wedge within the first slot by translating the cable until the first wedge becomes wedged within the first slot.

By securing the first wedge within the first slot, the first cable may similarly be secured within the body of the cable retainer assembly. Accordingly, with the wedge secured, the method may move to block 760, which may involve repeating the method steps outlined in blocks 710-750 with a subsequent (e.g., second, etc.) cable until each of the plurality of cables have been secured within the cable retainer assembly.

As should be appreciated in view of the foregoing, a cable retainer assembly is disclosed. The cable retainer assembly includes a body having a proximal end, a distal end positioned opposite the proximal end, and a body length extending from the proximal end to the distal end. A plurality of projections extend laterally about the body in a circumferential direction, and a plurality of slots are defined between each of the plurality of projections (e.g., between each pair of adjacent projections). In these embodiments, the cable retainer further includes a plurality of cross members that extend perpendicularly from each of the plurality of projections, with each of the plurality of cross members being tapered from a first cross member end to a second cross member end. A plurality of wedges are configured to be received by the plurality of slots, and each of the plurality of wedges are tapered from a first wedge end to a second wedge end, such that, when each of the plurality of wedges are inserted into each of the plurality of slots, each of the plurality of wedges become secured within each of the plurality of slots as each of the plurality of wedges are advanced through each of the plurality of slots from the proximal end of the body towards the distal end of the body. Each of the plurality of wedges may be further configured to engage a cable, such as a fiber optic cable, prior to being inserted into each of the plurality of slots. Accordingly, securing each of the plurality of wedges within each of the plurality of slots may further cause the cable to become secured within the cable retainer assembly. It should be appreciated that, by securing a plurality of cables within a single cable retainer assembly, the disclosed cable retainer may offer the simplicity and ease of installation of conventional wedge-style dead-end retainers without overcrowding attachment locations.

Further aspects of the embodiments described herein are provided by the subject matter of the following clauses:

Clause 1. A cable retainer assembly comprising: a body having a proximal end, a distal end positioned opposite the proximal end, and a body length extending from the proximal end to the distal end; a plurality of projections extending laterally about the body in a circumferential direction; a plurality of slots defined between each of the plurality of projections; a plurality of cross members extending perpendicularly from each of the plurality of projections, each of the plurality of cross members being tapered; and a plurality of wedges configured to be received by the plurality of slots; wherein each of the plurality of wedges are tapered, such that each of the plurality of wedges are retained in each of the plurality of slots when each of the plurality of wedges translates from the proximal end of the body towards the distal end of the body.

Clause 2. The cable retainer assembly of clause 1, wherein each of the plurality of projections extends along the body length of the body.

Clause 3. The cable retainer assembly of clauses 1 or 2, wherein each of the plurality of slots extends along the body length of the body.

Clause 4. The cable retainer assembly of any of clauses 1-3, wherein each of the plurality of cross members extends along the body length of the body.

Clause 5. The cable retainer assembly of any of clauses 1-4, wherein each of the plurality of cross members are tapered such that a distance between each of the plurality of slots and each of the plurality of cross members decreases from the proximal end of the body to the distal end of the body.

Clause 6. The cable retainer assembly of any of clauses 1-5, wherein each of the plurality of wedges are tapered such that a wedge thickness of each of the plurality of wedges decreases from a first end of each of the plurality of wedges to a second end of each of the plurality of wedges.

Clause 7. The cable retainer assembly of any of clauses 1-6, wherein each of the plurality of wedges includes a plurality of teeth positioned on at least one surface, the plurality of teeth being configured to engage a cable.

Clause 8. The cable retainer assembly of any of clauses 1-7, further comprising a central opening that receives an attachment mechanism, wherein the attachment mechanism is configured to secure the cable retainer assembly to an attachment location.

Clause 9. The cable retainer assembly of any of clauses 1-8, wherein at least a first end of each of the plurality of wedges extends from the proximal end of the body when each of the plurality of wedges are retained in each of the plurality of slots.

Clause 10. The cable retainer assembly of any of clauses 1-9, wherein at least a first end of each of the plurality of wedges lies flush with a proximal face of the body when each of the plurality of wedges are retained in each of the plurality of slots.

Clause 11. The cable retainer assembly of any of clauses 1-10, wherein a wedge length of each of the plurality of wedges is different than the body length of the body.

Clause 12. A cable retainer assembly comprising: a body having a proximal end, a distal end positioned opposite the proximal end, a body length extending from the proximal end to the distal end, and a plurality of sides extending along the body length; a plurality of channels formed in each of the plurality of sides; a plurality of slots defined within each of the plurality of channels, each of the plurality of slots being tapered; and a plurality of wedges configured to be received by the plurality of slots; wherein each of the plurality of wedges are tapered, such that each of the plurality of wedges are retained in each of the plurality of slots when each of the plurality of wedges translates from the proximal end of the body towards the distal end of the body.

Clause 13. The cable retainer assembly of clause 12, wherein each of the plurality of slots extends along the body length of the body.

Clause 14. The cable retainer assembly of clause 12 or 13, wherein each of the plurality of wedges are tapered such that a wedge thickness of each of the plurality of wedges decreases from a first end of each of the plurality of wedges to a second end of each of the plurality of wedges.

Clause 15. The cable retainer assembly of any of clauses 12-14, wherein each of the plurality of wedges includes a plurality of teeth positioned on at least one surface, the plurality of teeth being configured to engage a cable.

Clause 16. The cable retainer assembly of any of clauses 12-15, wherein at least one of the plurality of channels defines an opening that receives an attachment mechanism, wherein the attachment mechanism is configured to secure the cable retainer assembly to an attachment location.

Clause 17. The cable retainer assembly of any of clauses 12-16, wherein at least a first end of each of the plurality of wedges extends from the proximal end of the body when each of the plurality of wedges are retained in each of the plurality of slots.

Clause 18. The cable retainer assembly of any of clauses 12-17, wherein at least a first end of each of the plurality of wedges lies flush with a proximal face of the body when each of the plurality of wedges are retained in each of the plurality of slots.

Clause 19. The cable retainer assembly of any of clauses 12-18, wherein a wedge length of each of the plurality of wedges is different than the body length of the body.

Clause 20. A method of securing cables within a cable retainer assembly, the method comprising: (a) securing the cable retainer assembly to an attachment location using an attachment mechanism that extends through a central opening of the cable retainer assembly; (b) inserting a first cable of a plurality of cables into a first slot of a plurality of slots defined between a plurality of projections that extend from a body of the cable retainer assembly; (c) securing a first wedge of a plurality of wedges to at least a portion of the first cable; (d) translating the first cable such that the first wedge is drawn into the first slot; (e) securing the first wedge within the first slot, such that the first cable is secured within the first slot of the body of the cable retainer assembly; and (f) repeating method steps (a)-(e) such that each of the plurality of cables are secured within each of the plurality of slots of the cable retainer assembly.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A cable retainer assembly comprising:
a body having a proximal end, a distal end positioned opposite the proximal end, and a body length extending from the proximal end to the distal end;
a plurality of projections extending laterally about the body in a circumferential direction;
a plurality of slots defined between each of the plurality of projections;
a plurality of cross members extending perpendicularly from each of the plurality of projections, each of the plurality of cross members being tapered; and
a plurality of wedges configured to be received by the plurality of slots;
wherein each of the plurality of wedges are tapered, such that each of the plurality of wedges are retained in each of the plurality of slots when each of the plurality of wedges translates from the proximal end of the body towards the distal end of the body.

2. The cable retainer assembly of claim 1, wherein each of the plurality of projections extends along the body length of the body.

3. The cable retainer assembly of claim 1, wherein each of the plurality of slots extends along the body length of the body.

4. The cable retainer assembly of claim 1, wherein each of the plurality of cross members extends along the body length of the body.

5. The cable retainer assembly of claim 1, wherein each of the plurality of cross members are tapered such that a distance between each of the plurality of slots and each of the plurality of cross members decreases from the proximal end of the body to the distal end of the body.

6. The cable retainer assembly of claim 1, wherein each of the plurality of wedges are tapered such that a wedge thickness of each of the plurality of wedges decreases from a first end of each of the plurality of wedges to a second end of each of the plurality of wedges.

7. The cable retainer assembly of claim 1, wherein each of the plurality of wedges includes a plurality of teeth positioned on at least one surface, the plurality of teeth being configured to engage a cable.

8. The cable retainer assembly of claim 1, further comprising a central opening that receives an attachment mechanism, wherein the attachment mechanism is configured to secure the cable retainer assembly to an attachment location.

9. The cable retainer assembly of claim 1, wherein at least a first end of each of the plurality of wedges extends from the proximal end of the body when each of the plurality of wedges are retained in each of the plurality of slots.

10. The cable retainer assembly of claim 1, wherein at least a first end of each of the plurality of wedges lies flush with a proximal face of the body when each of the plurality of wedges are retained in each of the plurality of slots.

11. The cable retainer assembly of claim 1, wherein a wedge length of each of the plurality of wedges is different than the body length of the body.

12. A cable retainer assembly comprising:
a body having a proximal end, a distal end positioned opposite the proximal end, a body length extending from the proximal end to the distal end, and a plurality of sides extending along the body length;
a plurality of channels formed in each of the plurality of sides;
a plurality of slots defined within each of the plurality of channels, each of the plurality of slots being tapered; and
a plurality of wedges configured to be received by the plurality of slots;
wherein each of the plurality of wedges are tapered, such that each of the plurality of wedges are retained in each of the plurality of slots when each of the plurality of wedges translates from the proximal end of the body towards the distal end of the body.

13. The cable retainer assembly of claim 12, wherein each of the plurality of slots extends along the body length of the body.

14. The cable retainer assembly of claim 12, wherein each of the plurality of wedges are tapered such that a wedge thickness of each of the plurality of wedges decreases from a first end of each of the plurality of wedges to a second end of each of the plurality of wedges.

15. The cable retainer assembly of claim 12, wherein each of the plurality of wedges includes a plurality of teeth positioned on at least one surface, the plurality of teeth being configured to engage a cable.

16. The cable retainer assembly of claim 12, wherein at least one of the plurality of channels defines an opening that receives an attachment mechanism, wherein the attachment mechanism is configured to secure the cable retainer assembly to an attachment location.

17. The cable retainer assembly of claim 12, wherein at least a first end of each of the plurality of wedges extends from the proximal end of the body when each of the plurality of wedges are retained in each of the plurality of slots.

18. The cable retainer assembly of claim 12, wherein at least a first end of each of the plurality of wedges lies flush with a proximal face of the body when each of the plurality of wedges are retained in each of the plurality of slots.

19. The cable retainer assembly of claim 12, wherein a wedge length of each of the plurality of wedges is different than the body length of the body.

20. A method of securing cables within a cable retainer assembly, the method comprising:
(a) securing the cable retainer assembly to an attachment location using an attachment mechanism that extends through an opening of the cable retainer assembly;
(b) inserting a first cable of a plurality of cables into a first slot of a plurality of slots defined between a plurality of projections that extend from a body of the cable retainer assembly;
(c) securing a first wedge of a plurality of wedges to at least a portion of the first cable;
(d) translating the first cable such that the first wedge is drawn into the first slot;
(e) securing the first wedge within the first slot, such that the first cable is secured within the first slot of the body of the cable retainer assembly; and
(f) repeating method steps (a)-(e) such that each of the plurality of cables are secured within each of the plurality of slots of the cable retainer assembly.
